(19) United States
(12) Patent Application Publication
(10) Pub. No.: US 2021/0295775 A1
(43) Pub. Date: Sep. 23, 2021

(54) DIFFERENTIAL INPUT CIRCUIT AND DRIVING CIRCUIT

(71) Applicant: NOVATEK MICROELECTRONICS CORP., HsinChu (TW)

(72) Inventors: Chieh-An LIN, Taipei City (TW); Tzu-Chien TZENG, Hsinchu City (TW)

(21) Appl. No.: 16/820,805

(22) Filed: Mar. 17, 2020

(51) Int. Cl. G09G 3/3258

(52) U.S. Cl. CPC G09G 3/3258; G09G 2320/04; G09G 2310/0289

(57) ABSTRACT

A differential input circuit and a driving circuit including the same are provided. The differential input circuit transforms an analog voltage signal corresponding to a sensing line on an OLED panel to a pair of differential input signals being output to a gain amplifier. The differential input circuit includes a sampling circuit and a scaling circuit. The sampling circuit receives the analog voltage signal and a reference voltage through a first scaling path and a second scaling path, respectively. The scaling circuit includes a first scaling path and a second scaling path. The first scaling path and the second scaling path collectively generate the pair of differential input signals, based on a first shift voltage, a first scaled voltage, a second shift voltage, and a second scaled voltage. The first shift voltage is less than the second shift voltage.

### BACKGROUND OF THE INVENTION

### Field of the Invention

The invention relates in general to a differential input circuit and a driving circuit, and more particularly to a differential input circuit with sample and hold function and a driving circuit capable of transforming a sensed voltage signal to a low-voltage input of an analog-to-digital converter.

### DESCRIPTION OF THE RELATED ART

FIG. 1 is a schematic diagram illustrating the operation of an OLED pixel circuit. An organic light-emitting diode (hereinafter, OLED) panel includes OLED pixel circuits being arranged in a matrix, and an OLED pixel circuit 17 located at an m-th column and n-th row can be represented as PXLₘₙ. The OLED pixel circuit 17 is electrically connected to a source driver through an m-th data line DLₘ and an m-th sensing line SLₘ, and to a gate driver through an n-th gate line GLₙ. Both the source driver and the gate driver receive control signals specific to the OLED pixel circuit 17 from a timing controller.

When the OLED pixel circuit (PXLₘₙ) 17 is selected to display, the gate control signal being transmitted by the n-th gate line GLₙ switches on the transistor 17a, and the data signal being transmitted through the m-th data line DLₘ, charges the pixel capacitor Cₚₓₗ. Once the cross voltage of the pixel capacitor Cₚₓₗ is sufficient to turn on the driving transistor 17b (for example, a thin film transistor, hereinafter, TFT), a pixel driving current I_{drv} generates and drives the OLED 17d.

Characteristics of the OLED pixel circuit 17, for example, a threshold voltage Vth of the driving transistor 17b and the turn-on voltage of the OLED 17d, may shift or degrade with time passing. Thus, a sensing mechanism for detecting the OLED and/or TFT degradation must be introduced.

When the switch 17c is turned on, the OLED and/or TFT degradation can be measured based on signals sensed from the sensing lines on the OLED panel. An OLED data driver includes a display data driving circuit, and a sensing circuit for processing the signals sensed from the sensing lines. The sensing circuit has an analog-to-digital converter (hereinafter, ADC) to convert the sensed signal (which is an analog voltage signal) to digital sensing information to be transmitted to a timing controller or a core processor, which is responsible for data compensation on the image data to be displayed.

However, the range of the analog sensing signal is greater than the operating voltage range of the ADC. Therefore, a technique for transforming the analog sensing signal to the low-voltage range of the ADC is desired.

### SUMMARY OF THE INVENTION

The invention is directed to a differential input circuit and a driving circuit including the same. The differential input circuit transforms an analog voltage signal in a single-end form to a pair of differential input signals for a gain amplifier, and the signal quality can be improved.

According to a first aspect of the present disclosure, a differential input circuit is provided. The differential input circuit transforms an analog voltage signal corresponding to a sensing line on an OLED panel to a pair of differential input signals being output to a gain amplifier. The differential input circuit includes a sampling circuit and a scaling circuit. The sampling circuit is configured to receive the analog voltage signal and a reference voltage. The sampling circuit includes a first sampling path and a second sampling path. The first sampling path is configured to selectively sample the analog voltage signal to generate a first sampling voltage between a first sensing terminal and a first reference terminal according to the analog voltage signal and the reference voltage. The second sampling path is configured to selectively sample the analog voltage signal to generate a second sampling voltage between a second reference terminal and a second sensing terminal according to the reference voltage and the analog voltage signal. The scaling circuit includes a first scaling path and a second scaling path. The first scaling path is electrically connected to the first sensing terminal and the first reference terminal. The first scaling path is configured to receive the first sampling voltage and a first shift voltage, down scale the first sampling voltage to a first scaled voltage, and generate one of the pair of differential input signals according to the first shift voltage and the first scaled voltage. The second scaling path is electrically connected to the second sensing terminal and the second reference terminal. The second scaling path is configured to receive the second sampling voltage and a second shift voltage, down scale the second sampling voltage to a second scaled voltage, and generate the other one of the pair of differential input signals according to the second shift voltage and the second scaled voltage. The first and the second shift voltages are direct current voltages, and the first shift voltage is less than the second shift voltage.

According to a second aspect of the present disclosure, a driving circuit of a display device is provided. The driving circuit includes a differential input circuit and a gain amplifier. The differential input circuit transforms an analog voltage signal corresponding to a sensing line on an OLED panel to a pair of differential input signals. The differential input circuit includes a sampling circuit and a scaling circuit. The sampling circuit is configured to receive the analog voltage signal and a reference voltage. The sampling circuit includes a first sampling path and a second sampling path. The first sampling path is configured to selectively sample the analog voltage signal to generate a first sampling voltage between a first sensing terminal and a first reference terminal according to the analog voltage signal and the reference voltage. The second sampling path is configured to selectively sample the analog voltage signal to generate a second sampling voltage between a second reference terminal and a second sensing terminal according to the reference voltage and the analog voltage signal. The scaling circuit includes a first scaling path and a second scaling path. The first scaling path is electrically connected to the first sensing terminal and the first reference terminal. The first scaling path is configured to receive the first sampling voltage and a first shift voltage, down scale the first sampling voltage to a first scaled voltage, and generate one of the pair of differential input signals according to the first shift voltage and the first scaled voltage. The second scaling path is electrically connected to the second sensing terminal and the second reference terminal. The second scaling path is configured to receive the second sampling voltage and a second shift voltage, down scale the second sampling voltage to a second scaled voltage, and generate the other one of the pair of differential input signals according to the second shift voltage and the second scaled voltage. The first and the second shift voltages are direct current voltages, and the first shift voltage is less than the second shift voltage. The gain amplifier is electrically connected to the differential input circuit. The gain amplifier includes a first input terminal, a second input terminal, a first output terminal, and a second output terminal. The gain amplifier is configured to receive the pair of differential input signals through the first and the second input terminals and generate a pair of differential output signals at the first and the second output terminals.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 (prior art) is a schematic diagram illustrating the operation of an OLED pixel circuit.

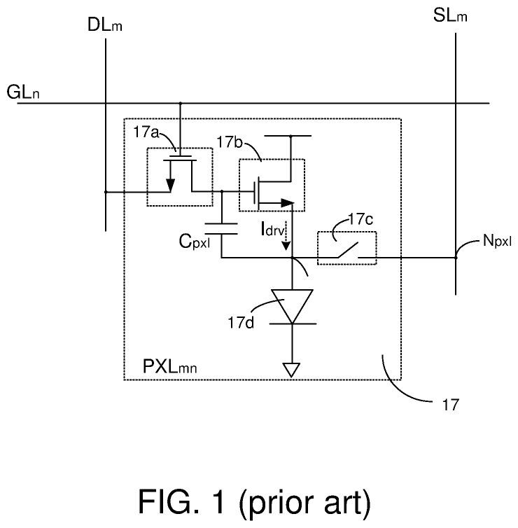

FIG. 2 is a schematic diagram illustrating components related to sensing the OLED and/or TFT degradation information of the pixel circuits in an OLED display device.

FIG. 3A is a schematic diagram illustrating a driving circuit according to the embodiment of the present disclosure.

FIG. 3B is a waveform diagram illustrating changes of the signals shown in FIG. 3A.

FIG. 4 is a schematic diagram illustrating a differential input circuit according to the embodiment of the present disclosure.

FIG. 5 and FIG. 6 are schematic diagrams respectively illustrating the differential input circuit operating in a sampling phase and in a hold phase (voltage scaling phase) according to the embodiment of the present disclosure.

FIG. 7 is a schematic diagram illustrating the gain amplifier operates in the amplification mode. FIG. 7 is corresponding to the sixth duration T6 shown in FIG. 3B.

FIG. 8 is a schematic diagram illustrating an example of the implementation of the differential input circuit according to the embodiment of the present disclosure.

FIG. 9 is a schematic diagram illustrating the characteristic of the differential input circuit according to the embodiment of present disclosure.

FIG. 10 is a schematic diagram illustrating the conversion characteristic of the ADC.

### DETAILED DESCRIPTION OF THE INVENTION

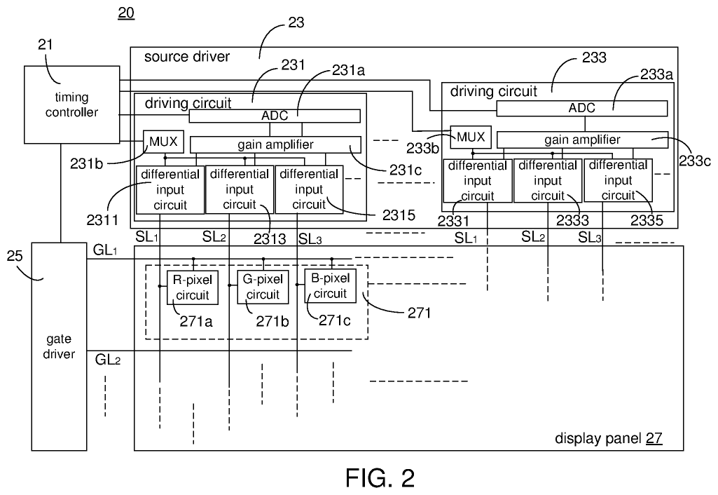

FIG. 2 is a schematic diagram illustrating components related to sensing the OLED and/or TFT degradation information of the OLED pixel circuits in an OLED display device. The OLED display device 20 includes a display panel 27, a source driver 23, a timing controller 21, and a gate driver 25. Both the timing controller 21 and the display panel 27 are electrically connected to the source driver 23 and the gate driver 25.

The display panel 27 display images with basic display elements 271 (pixels), and each of the basic display elements 271 includes an R-pixel circuit 271a, a G-pixel circuit 271b, and a B-pixel circuit 271c.

The source driver 23 may include one or multiple driving circuits 231, 233, and each of the driving circuits 231, 233 further includes an ADC 231a, 233a, a multiplexer (hereinafter, MUX) 231b, 233b, a gain amplifier 231c, 233c, and multiple differential input circuits 2311, 2313, 2315, 2331, 2333, 2335. As the components and interconnections in the driving circuits 231, 233 are similar, only the driving circuit 231 is illustrated. Each driving circuit may be implemented as a semiconductor chip.

The differential input circuit 2311 receives a first-channel (ch1) analog voltage signal through the sensing line SL₁. The differential input circuit 2313 receives a second-channel (ch2) analog voltage signal V_{th(ch2)} through the sensing line SL₂. The differential input circuit 2315 receives a third-channel (ch3) analog voltage signal V_{th(ch3)} through the sensing line SL₃. It is noted that FIG. 2 is an exemplary diagram, and the sensing lines SL₁˜SL₃ and the pixel columns are not necessary to be in a one-on-one relationship. Based on the analog voltage signals respectively received from the sensing lines SL₁˜SL₃, the OLED/TFT degradation information may be acquired.

According to the embodiment of the present disclosure, the number of driving circuits 231, 233 included in the source driver 23 is not limited. As shown in FIG. 2, the driving circuits 231, 233 may include multiplexers 231b, 231c, so that it is possible to equip one ADC in every driving circuit 231, 233.

After receiving the analog voltage signals from the sensing lines SL₁˜SL₃, the differential input circuits 2311, 2313, 2315 samples, and scales down the analog voltage signals. Then, the ADCs 231a, 233a transform the scaled analog voltage signals into digitals signal representing ADC codes. The digital signals are further transmitted to the timing controller 21.

As the digital signals originated from the analog voltage signals carrying the OLED and/or TFT degradation information of the OLED pixel circuits, the ADC codes can reflect the degradation statuses of the OLED/TFT of the OLED pixel circuits.

According to the embodiment of the present disclosure, the multiplexer 231b receives selection signals ENₛₑₗ from the timing controller 21. Basically, the selection signals ENₛₑₗ are separately corresponding to the differential input circuits 2311, 2313, 2315, and the differential input circuits 2311, 2313, 2315. With the selection signals ENₛₑₗ, the ADC 231a rotativity generates the digital signals corresponding to the differential input circuits 2311, 2313, 2315. In consequence, the timing controller 21 is capable of compensating the OLED and/or TFT degradation of the OLED panel.

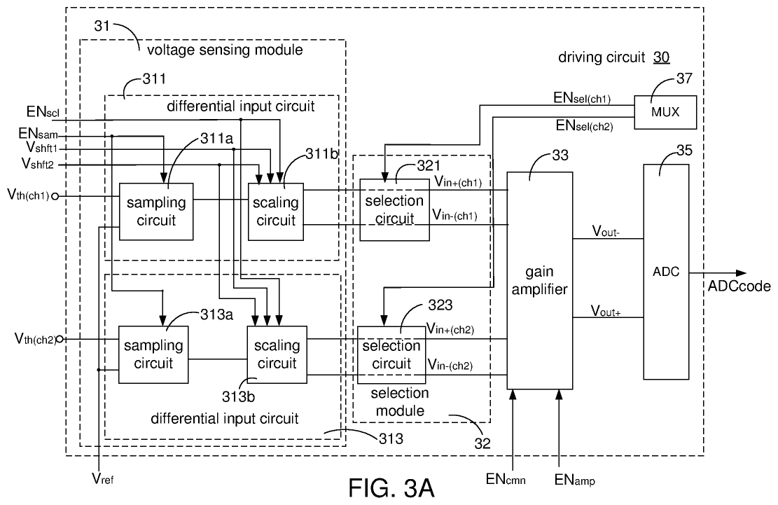

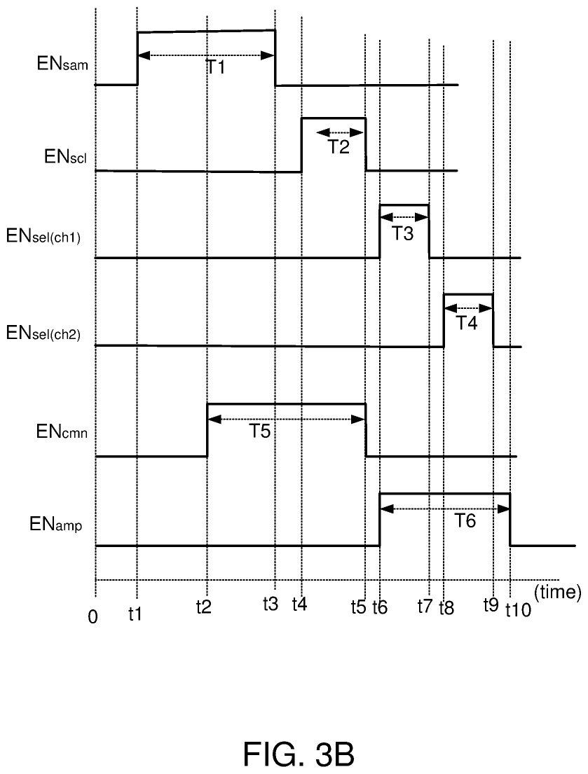

FIG. 3A is a schematic diagram illustrating a driving circuit according to the embodiment of the present disclosure. The driving circuit 30 includes a voltage sensing module 31, a selection module 32, a gain amplifier 33, an ADC 35, and a multiplexer 27. Depending on the number of channels to be supported by the driving circuit 30, the number of differential input circuits 311, 313 in the voltage sensing module 31 may vary. That is, a plurality of differential input circuits 311, 313 generate their outputs to the gain amplifier 33 in a time-multiplexing manner.

For illustration purposes, the driving circuit 30 in FIG. 3A is assumed to support two channels. Thus, the voltage sensing module 31 includes two differential input circuits 311, 313, and the selection module 32 includes two selection circuits 321, 323. The differential input circuit 311 and the selection circuit 321 are respectively corresponding to a first channel (ch1), and the differential input circuit 313 and the selection circuit 323 are respectively corresponding to a second channel (ch2).

According to the embodiment of the present disclosure, some signals are channel specific, but others are not. For example, a reference voltage V_{ref}, a first shift voltage V_{shft1}, a second shift voltage V_{shft2}, a sampling enable signal ENₛₐₘ, and a scaling enable signal EN_{scl} are signals being transmitted to both the differential input circuits 311, 313. On the other hand, the analog voltage signals V_{th(ch1)}, V_{th(ch2)} and the channel selection signals EN_{sel(ch1)}, EN_{sel(ch2)} are channel specific. In the following context, the signals specific to individual channels are marked in brackets if necessary.

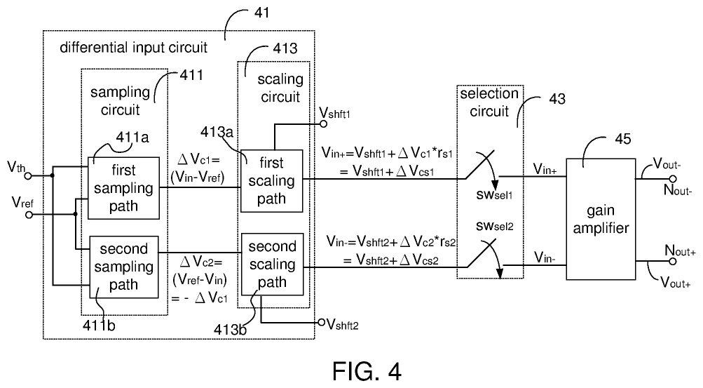

The differential input circuit 311 includes a sampling circuit 311a and a scaling circuit 311b. Similarly, the differential input circuit 313 includes a sampling circuit 313a and a scaling circuit 313b. The signals and operations of the differential input circuit 313 are similar to those of the differential input circuit 311. Thus, only one differential input circuit is illustrated as an example in the following figures (FIGS. 4-8).

The sampling circuits 311a, 313a are respectively electrically connected to the scaling circuits 311b, 313b. Both the sampling circuits 311a, 313a are controlled by the sampling enable signal ENₛₐₘ and the reference voltage V_{ref}. Both the scaling circuits 311b, 313b are controlled by the scaling enable signal EN_{scl}, the first shift voltage V_{shft1}, and the second shift voltage V_{shft2}.

The sampling enable signal ENₛₐₘ, and the scaling enable signal EN_{scl} are pulse signals issued by the timing controller (not illustrated). The generation and timing of the sampling enable signal ENₛₐₘ, and the scaling enable signal EN_{scl} are related and briefly illustrated in FIG. 3B. In short, the sampling enable signal ENₛₐₘ, and the scaling enable signal EN_{scl} are alternatively generated, and the pulse of the sampling enable signal ENₛₐₘ is prior to the pulse of the scaling enable signal EN_{scl}.

The scaling circuits 311b, 313b are respectively electrically connected to the selection circuits 321, 323. The selection circuit 321 transmits the pair of differential input signals corresponding to the first channel (V_{in+(ch1)}, V_{in-(ch1)}) to the gain amplifier 33, and the selection circuit 321 transmits the pair of differential input signals corresponding to the second channel (V_{in+(ch2)}, V_{in-(ch2)}) to the gain amplifier 33. The multiplexer 37 generates and transmits two channel selection signals EN_{sel(ch1)}, EN_{sel(ch2)} to the selection circuits 321, 323, respectively. Basically, the channel selection signals EN_{sel(ch1)}, EN_{sel(ch2)} are utilized to select which of the selection circuits 321, 323 can transmit their output signals to the gain amplifier 33.

The gain amplifier 33 may operate in a common mode (M_{cmn}) or in an amplification mode (Mₐₘₚ). The timing controller controls the gain amplifier 33 to operate in the common mode (M_{cmn}) with a common mode signal EN_{cmn}, and in the amplification mode (Mₐₘₚ) with an amplification mode signal ENₐₘₚ.

When the gain amplifier 33 operates in the common mode (M_{cmn}), none of the selection circuits 321, 323 transmits the differential input signals (V_{in+(ch1)}, V_{in-(ch1)}), (V_{in+(ch1)}, (V_{in-(ch2)}) to the gain amplifier 33.

When the gain amplifier 33 operates in the amplification mode (Mₐₘₚ), one of the selection circuits 321, 323 transmits the pair of differential input signals (V_{in+(ch1)}, V_{in-(ch1)}), (V_{in+(ch2)}, V_{in-(ch2)}) to the gain amplifier 33, the gain amplifier 33 generates and transmits the pair of differential output signals (Vₒᵤₜ₊, Vₒᵤₜ₋) to the ADC 35, and the ADC 35 converts the differential output signals (Vₒᵤₜ₊, Vₒᵤₜ₋) to the digital signal. The input range of the ADC 35 is relatively lower than the voltage range of the analog voltage signal being sensed. The practical values of the input range and the output range of the ADC 35 are not limited.

FIG. 3B is a waveform diagram illustrating changes of the signals shown in FIG. 3A. The vertical axis represents different signals, and the horizontal axes represent time. The voltage levels of these signals shown here are examples and not limited in practical application.

The first waveform represents the sampling enable signal ENₛₐₘ, and the second waveform represents the scaling enable signal EN_{scl}. The third and the fourth waveforms represent channel selection signals (EN_{sel(ch1)}, EN_{sel(ch2)}) to be respectively transmitted to the selection circuits 321, 323. The fifth waveform is a common mode signal EN_{cmn}, and the sixth waveform is an amplification mode signal ENₐₘₚ.

The sampling enable signal ENₛₐₘ significantly transits from a low voltage level to a high voltage level at time point t1, and transits from the high voltage level to the low voltage level at time point t3. The duration when the sampling enable signal ENₛₐₘ is at the high voltage level is represented as a first duration T1. The sampling circuits 311a, 313a are enabled by the sampling enable signal ENₛₐₘ during the first duration T1.

The scaling enable signal EN_{scl} significantly transits from a low voltage level to a high voltage level at time point t4, and transits from the high voltage level to the low voltage level at time point t5. The duration when the scaling enable signal EN_{scl} is at the high voltage level is represented as a second duration T2. The end time point of the first duration T1 is the same as or before the start time point of the second duration T2. The short duration between the first duration T1 and the second duration T2 can be defined to prevent signal confliction.

The sampling circuits 311a, 313a respectively sample the analog voltage signals V_{th(ch1)}, V_{th(ch2)}) during the first duration T1. During the second duration T2, the scaling circuit 311b generates a pair of differential input signals (V_{in+(ch1)}, V_{in-(ch1)}), and the scaling circuit 313b generates another pair of differential input signals (V_{in+(ch2)}, V_{in-(ch2)}).

The sampling circuits 311a, 313a simultaneously receive the sampling enable signal ENₛₐₘ, and the scaling circuits 311b, 313b simultaneously receive the scaling enable signal EN_{scl}. Alternatively speaking, operations of the sampling circuits 311a, 313a are synchronized, and operations of the scaling circuits 311b, 313b are synchronized. That is, the pair of differential input signals (V_{in+(ch1)}, V_{in-(ch1)}), and another pair of differential input signals (V_{in+(ch2)}, V_{in-(ch2)})) are generated at the same time.

The channel selection signal EN_{sel(ch1)} specific to the first channel (ch1) transits from the low voltage level to the high voltage level at time point t6, and transits from the high voltage level to the low voltage level at time point t7. The duration when the channel selection signal EN_{sel(ch1)} specific to the first channel (ch1) is at the high voltage level is represented as a third duration T3. The end time point of the second duration T2 is the same as or before the start time point of the third duration T3. The short duration between the second duration T2 and the third duration T3 can be defined to prevent signal confliction.

The channel selection signal EN_{sel(ch2)} specific to the second channel (ch2) transits from the low voltage level to the high voltage level at time point t8, and transits from the high voltage level to the low voltage level at time point t9. The duration when the channel selection signal EN_{sel(ch2)} specific to the second channel (ch2) is at the high voltage level is represented as a fourth duration T4. The end time point of the third duration T3 is the same as or before the start time point of the fourth duration T4. The short duration between the third duration T3 and the fourth duration T4 can be defined to prevent signal confliction.

In FIG. 3B, the common mode signal EN_{cmn} is assumed to transit from the low voltage level to the high voltage level at time point t2, and transits from the high voltage level to the low voltage level at time point t5. The duration when the common mode signal EN_{cmn} is at the high voltage level is represented as a fifth duration T5.

According to the embodiment of the present disclosure, the gain amplifier 33 must acquire a common mode voltage V_{cmn} before the selection module 32 receives the channel selection signals EN_{sel(ch1)}, EN_{sel(ch2)}. For example, the start time point of the fifth duration T5 can be between time point t1 and t4, and the end time point of the fifth duration T5 can be before or the same as the time point t6.

The amplification mode signal ENₐₘₚ transits from the low voltage level to the high voltage level at time point t6, and transits from the high voltage level to the low voltage level at time point t10. The duration when the amplification mode signal ENₐₘₚ is at the high voltage level is represented as a sixth duration T6. The end time point of the fifth duration T5 is the same as or before the start time point of the sixth duration T6. The short duration between the fifth duration T5 and the sixth duration T6 can be defined to prevent signal confliction.

Based on the waveforms shown in FIG. 3B, the differential input circuits 311, 313 transform the analog voltage signals corresponding to sensing lines to pairs of differential input signals (V_{in+(ch1)}, V_{in-(ch1)}), (V_{in+(ch2)}, V_{in-(ch2)}) of the gain amplifier 33. Details of the design and operation of the differential input circuit according to the embodiment of the present disclosure are illustrated below. For the sake of illustration, only one differential input circuit is illustrated as an example.

FIG. 4 is a schematic diagram illustrating a differential input circuit according to the embodiment of the present disclosure. The differential input circuit 41 includes a sampling circuit 411 and a scaling circuit 413. The sampling circuit 411 further includes a first sampling path 411a and a second sampling path 411b, and the scaling circuit 413 further includes a first scaling path 413a and a second scaling path 413b. The first scaling path 413a is electrically connected to the first sampling path 411a and the selection circuit 43. The second scaling path 413b is electrically connected to the second sampling path 411b and the selection circuit 43.

The sampling circuit 411 receives the analog voltage signal Vₜₕ and a reference voltage V_{ref}. The first sampling circuit 411a selectively generates a first sampling voltage ΔV_{c1} according to the analog voltage signal Vₜₕ and the reference voltage V_{ref}, that is, ΔV_{c1}=Vₜₕ−V_{ref}. The second sampling path 411b selectively generates a second sampling voltage ΔV_{c2} according to the reference voltage V_{ref} and the analog voltage signal Vₜₕ.

The first scaling path 413a receives the first sampling voltage ΔV_{c1} and a first shift voltage V_{shft1}, down scales the first sampling voltage ΔV_{c1} to a first scaled voltage ΔV_{cs1} with a first scaling ratio rₛ₁, and generates one of the pair of differential input signals (for example, a non-inverting differential input signal Vᵢₙ₊) according to the first shift voltage V_{shft1} and the first scaled voltage ΔV_{cs1}. That is, ΔV_{cs1}=ΔV_{c1}*rₛ₁, and Vᵢₙ₊=V_{shft1}+ΔV_{c1}*rₛ₁=V_{shft1}+ΔV_{cs1}.

The second scaling path 413b receives the second sampling voltage ΔV_{c2} and a second shift voltage V_{shft1}, down scales the second sampling voltage ΔV_{c2} to a second scaled voltage ΔV_{cs2} with a second scaling ratio rₛ₂, and generates the other one of the pair of differential input signals (for example, an inverting differential input signal Vᵢₙ₋) according to the second shift voltage V_{shft2} and the second scaled voltage ΔV_{cs2}. That is, ΔV_{cs2}=ΔV_{c2}*rₛ₂, and Vᵢₙ₋=V_{shft2}+ΔV_{c2}*rₛ₂=V_{shft2}+ΔV_{cs2}.

According to the embodiment of the present disclosure, the first and the second shift voltages V_{shft1}, V_{shft2} are direct current (hereinafter, DC) voltages, and the first shift voltage V_{shft1} is less than the second shift voltage V_{shft2} (V_{shft1}<V_{shft2}). Moreover, a range of the pair of differential input signals (Vᵢₙ₊, Vᵢₙ₋) is less than or equivalent to the difference between the first and the second shift voltages V_{shft1}, V_{shft2}. That is, |Vᵢₙ₊−Vᵢₙ₋|≤|V_{shft1}−V_{shft2}|. According to the embodiment of the present disclosure, the first shift voltage V_{shft1} and the second shift voltage V_{shft2} may have the same absolute values and inversed polarities that are relative to a reference point. For example, the first shift voltage V_{shft1} is −0.5V, and the second shift voltage V_{shft2} is +0.5V, relative to a reference point 0V; or, the first shift voltage V_{shft1} is +1V and the second shift voltage V_{shft2} is +2V, relative to a reference point +0.5V.

The selection circuit 43 includes a first selection switch SWₛₑₗ₁ and a second selection switch SW₂. The selection circuit 43 is electrically connected to the gain amplifier 45. When the channel selection signal ENₛₑₗ corresponding to the differential input circuit 41 is at the high voltage level, the first selection switch SWₛₑₗ₁ and the second selection switch SWₛₑₗ₂ are switched on so that the first selection switch SWₛₑₗ₁ conducts the non-inverting differential input signal Vᵢₙ₊ to the gain amplifier 45 and the second selection switch SWₛₑₗ₂ conducts the inverting differential input signal Vᵢₙ₋ to the gain amplifier 45.

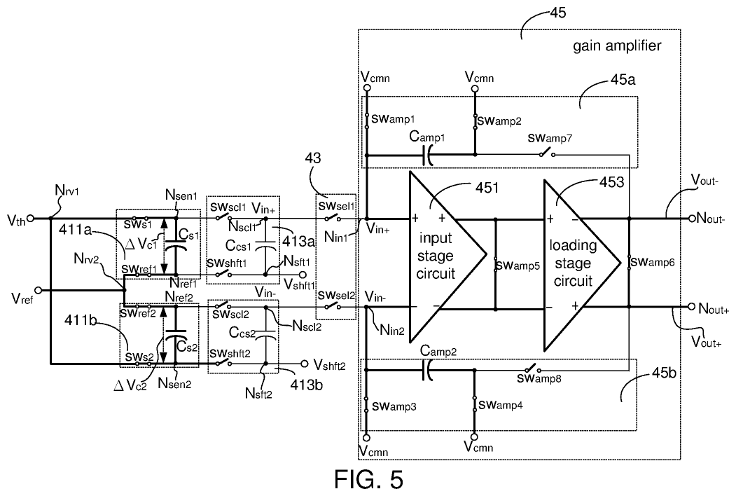

FIG. 5 and FIG. 6 are schematic diagrams respectively illustrating the differential input circuit operating in a sampling phase and in a hold phase (voltage scaling phase) according to the embodiment of the present disclosure. FIG. 5 is corresponding to the condition that the sampling enable signal ENₛₐₘ is at the high voltage level (for example, the first duration T1 shown in FIG. 3B). FIG. 6 is corresponding to the condition that the sampling enable signal ENₛₐₘ transits to the low voltage level and the scaling enable signal EN_{scl} is at the high voltage level (for example, the second duration T2 shown in FIG. 3B).

The internal components of the first sampling path 411a and the first scaling path 413a, and those of the second sampling path 411b and the second scaling path 413b are symmetric.

The first sampling path 411a and the first scaling path 413a jointly generate the non-inverting differential input signal Vᵢₙ₊ based on the analog voltage signal Vₜₕ, the reference voltage V_{ref} and the first shift voltage V_{shft1}, accompanied with control of the sampling enable signal ENₛₐₘ, and the scaling enable signal EN_{scl}.

The first sampling path 411a includes a first sampling switch swₛ₁, a first reference switch sw_{ref1} and a first sampling capacitor Cₛ₁. The first sampling switch swₛ₁ is electrically connected to a first receiving terminal Nᵣᵥ₁ and a first sensing terminal Nₛₑₙ₁. The first reference switch sw_{ref1} is electrically connected to a second receiving terminal Nᵣᵥ₂ and a first reference terminal N_{ref1}. The first sampling capacitor Cₛ₁ is electrically connected to the first sensing terminal Nₛₑₙ₁, and the first reference terminal N_{ref1}. When the sample enable signal ENₛₐₘ is at the high voltage level, the first sampling switch swₛ₁ transmits/conducts the analog voltage signal to the first sensing terminal Nₛₑₙ₁ and the first reference switch sw_{ref1} transmits/conducts the reference voltage V_{ref} to the first reference terminal N_{ref1} such that the first sampling capacitor Cₛ₁ are charged, and the first sampling voltage ΔV_{c1} is generated between the first sensing terminal Nₛₑₙ₁ and the first reference terminal N_{ref1}.

The first scaling path 413a includes a first scaling switch sw_{scl1}, a first shift switch sw_{shft1}, and a first charge sharing capacitor C_{cs1}. The first scaling switch sw_{scl1} is electrically connected to the first sensing terminal Nₛₑₙ₁ and a first scaling terminal N_{scl1}. The first shift switch sw_{shft1} is electrically connected to the first reference terminal N_{ref} and a first shift terminal N_{sft1}. The first charge sharing capacitor C_{cs1} is electrically connected to the first scaling terminal N_{scl1} and the first shift terminal N_{sft1}.

When the scaling enable signal EN_{scl} is at the high voltage level, the first scaling switch sw_{scl1} conducts the first sensing terminal Nₛₑₙ₁ to the first scaling terminal N_{scl1}, and the first shift switch sw_{shft1} conducts the first reference terminal N_{ref1} to the first shift terminal N_{sft1}. Meanwhile, the first charge sharing capacitor C_{cs1} receives the first shift voltage V_{shft1} through the first shift terminal N_{sft1}, and charges stored in the first sampling capacitor Cₛ₁ are shared by the first sampling capacitor Cₛ₁ and the first charge sharing capacitor C_{cs1}.

The second sampling path 411b and the second scaling path 413b jointly generate the inverting differential input signal Vᵢₙ₋ based on the analog voltage signal Vₜₕ, the reference voltage V_{ref} and the second shift voltage V_{shft2}, accompanied with control of the sampling enable signal ENₛₐₘ and the scaling enable signal EN_{scl}. Since the implementation of the second sampling path 411b and the second scaling path 413b are similar to those of the first sampling path 411a and the first scaling path 413a, details of which are not redundantly described.

The first sampling switch swₛ₁ and the first reference switch swᵣ, are switched on when the sampling enable signal ENₛₐₘ is at the high voltage level. Meanwhile, the first sampling capacitor Cₛ₁ is charged, and the first sampling voltage ΔV_{c1} is generated between the first sensing terminal Nₛₑₙ₁ and the first reference terminal N_{ref1}. When the scaling enable signal EN_{scl} is at the high voltage level, charges being accumulated in the first sampling capacitor Cₛ₁ in the sensing phase is jointly shared by two capacitors, that is, the first sampling capacitor Cₛ₁ and the first charge sharing capacitor C_{cs1}. In consequence, the voltage between the first scaling terminal N_{scl1} and the first shift terminal N_{sft1} decreases and becomes less than the first sampling voltage ΔV_{c1}. The voltage between the first scaling terminal N_{scl1} and the first shift terminal N_{sft1} after being scaled down is defined as a first scaled voltage ΔV_{cs1}.

Similarly, the second sampling switch swₛ₂ and the second reference switch sw_{ref2} are switched on when the sampling enable signal ENₛₐₘ is at the high voltage level. Meanwhile, the second sampling capacitor Cₛ₂ is charged, and the second sampling voltage ΔV_{c2} is generated between the second reference terminal N_{ref2} and the second sensing terminal Nₛₑₙ₂. When the scaling enable signal EN_{scl} is at the high voltage level, charges being accumulated in the second sampling capacitor Cₛ₂ in the sensing phase is jointly shared by two capacitors, that is, the first sampling capacitor Cₛ₁ and the first charge sharing capacitor C_{cs1}. In consequence, the voltage between the second scaling terminal N_{scl2} and the second shift terminal N_{sft2} decreases and becomes less than the second sampling voltage ΔV_{c2}. The voltage between the second scaling terminal N_{scl2} and the second shift terminal N_{sft2} after being scaled down is defined as a second scaled voltage ΔV_{cs2}.

According to the embodiment of the present disclosure, the reference voltage V_{ref}, the first shift voltage V_{shft1} and the second shift voltage V_{shft2} are direct current voltages. The first shift voltage V_{shft1} is lower than the second shift voltage V_{shft2} (V_{shft1}<V_{shft2}). The difference between the first and the second shift voltages (ΔV_{shft}) can be represented as ΔV_{shft}=V_{shft2}−V_{shft1}. Ranges of the pairs of the differential input signals (V_{in+(ch1)}, V_{in-(ch1)}), (V_{in+(ch2)}, V_{in-(ch2)}) are less than or equivalent to the difference between the first and the second shift voltages (ΔV_{shft}).

As shown in FIG. 5, the gain amplifier 45 can include an input stage circuit 451, a loading stage circuit 453, an interconnection path, a first conduction path 45a, and a second conduction path 45b. The first conduction path 45a is electrically connected to the first input terminal Nᵢₙ₁ and the first output terminal Nₒᵤₜ₋, and the second conduction path 45b is electrically connected to the second input terminal Nᵢₙ₂ and the second output terminal Nₒᵤₜ₊.

The input stage circuit 451 is electrically connected to the selection circuit 43, from which the differential input signals Vᵢₙ₊, Vᵢₙ₋ are received. The loading stage circuit 453 is electrically connected to the input stage circuit 452, the first output terminal Nₒᵤₜ₋, and the second output terminal Nₒᵤₜ₊. The interconnection path includes switches swₐₘₚ₅, swₐₘₚ₆, the first conduction path 45a includes switches swₐₘₚ₁, swₐₘₚ₂, swₐₘₚ₇, and an amplification capacitor Cₐₘₚ₁, and the second conduction path 45b includes switches swₐₘₚ₃, swₐₘₚ₄, swₐₘₚ₈, and another amplification capacitor Cₐₘₚ₂.

When the gain amplifier 45 operates in the common mode (M_{cmn}), switches swₐₘₚ₁, swₐₘₚ₂, swₐₘₚ₃, swₐₘₚ₄, swamps, swₐₘₚ₆ are switched on, and switches swₐₘₚ₇, swₐₘₚ₈ are switched off. Through switches swₐₘₚ₁, swₐₘₚ₂, the first conduction paths 45a receive the common mode voltage V_{cmn}. Through switches swₐₘₚ₃, swₐₘₚ₄, the second conduction paths 45b receive the common mode voltage V_{cmn}.

When the gain amplifier 45 operates in the amplification mode (Mₐₘₚ), the first conduction path 45a generates an inverting differential output signal Vₒᵤₜ₋ based on the common mode voltage V_{cmn} and the pair of differential input signals (Vᵢₙ₊, Vᵢₙ₋), and the second conduction path 45b generates the non-inverting differential output signal Vₒᵤₜ₊ based on the same.

As for the gain amplifier 45, FIG. 6 is corresponding to the condition that the gain amplifier 45 is in the common mode (M_{cmn}) (for example, the fifth duration T5 shown in FIG. 3B).

Since the first scaling switch sw_{scl1} and the first shift switch sw_{shft1} are turned on by the scaling enable signal EN_{scl}, the first charge sharing capacitor C_{cs1} shares charges stored in the first sampling capacitor Cₛ₁. In consequence, the first sampling voltage ΔV_{c1} is down scaled to the first scaled voltage ΔV_{cs1}, and the non-inverting differential input signal Vᵢₙ₊ is generated at the first scaling terminal N_{scl1}. The generation of the non-inverting differential input signal Vᵢₙ₊ can be represented as equation (1).

$${V}_{in +} = {V}_{shift 1} + Δ {{V}_{c 1}}^{*} {r}_{s 1} = {V}_{shift 1} + Δ {V}_{cs 1} = {V}_{shift 1} + Δ {{V}_{c 1}}^{*} {C}_{s 1} / ( {C}_{s 1} + {C}_{cs 1} ) \qquad equation ( 1 )$$

Since the second scaling switch sw_{scl2} and the second shift switch sw_{shft2} are turned on by the scaling enable signal EN_{scl}, the second charge sharing capacitor C_{cs2} shares charges stored in the second sampling capacitor Cₛ₂. In consequence, the second sampling voltage ΔV_{c2} is down scaled to the second scaled voltage ΔV_{cs2}, and the inverting differential input signal Vᵢₙ₋ is generated at the second scaling terminal N_{scl2}. Generation of the inverting differential input signal Vᵢₙ₋ can be represented as equation (2).

$${V}_{in \text{-}} = {V}_{shift 2} + Δ {V}_{cs 2} = {V}_{shift 2} + Δ {{V}_{c 2}}^{*} {C}_{s 2} / ( {C}_{s 2} + {C}_{cs 2} ) \qquad equation ( 2 )$$

The first sampling capacitor Cₛ₁ receives the analog voltage signal Vₜₕ and the reference voltage V_{ref} with its anode and cathode, respectively. The second sampling capacitor Cₛ₂ receives the analog voltage signal Vₜₕ and the reference voltage V_{ref} with its cathode and anode, respectively. Based on the assumption that Cₛ₁=Cₛ₂, magnitudes of the first sampling voltage ΔV_{c1} and the second sampling voltage ΔV_{c1} are equivalent but polarities of the first sampling voltage ΔV_{c1} and the second sampling voltage ΔV_{c2} are opposite.

The first scaling ratio rₛ₁ between the first scaled voltage ΔV_{cs1} and the first sampling voltage ΔV_{c1} thus can be determined based on capacitances of the first sampling capacitor Cₛ₁ and the first charge sharing capacitor C_{cs1}. For example, in a case that Cs1=C and Ccs1=2*C, ΔV_{cs1}=⅓*ΔV_{c1}. Similarly, the second scaling ratio rₛ₂ between the second scaled voltage ΔV_{cs2} and the second sampling voltage ΔV_{c2} can be determined based on capacitances of the second sampling capacitor Cₛ₂ and the second charge sharing capacitor C_{cs2}.

According to the embodiment of the present disclosure, capacitances of the first sampling capacitor Cₛ₁ and the second sampling capacitor Cₛ₂ are equivalent, and capacitances of the first charge sharing capacitor C_{cs1} and the second charge sharing capacitor C_{cs2} are equivalent. Therefore, the first scaling ratio rₛ₁ is equivalent to the second scaling ratio rₛ₂.

Based on these equivalences (Cₛ₁=Cₛ₂, C_{cs1}=C_{cs2}, and ΔV_{c2}=−ΔV_{c1}), equation (2) can be re-written as equation (3).

$${V}_{in \text{-}} = {V}_{shift 2} + Δ {V}_{cs 2} = {V}_{shift 2} + Δ {{V}_{c 2}}^{*} {C}_{s 2} / ( {C}_{s 2} + {C}_{cs 2} ) = {V}_{shift 2} \text{-} Δ {{V}_{c 1}}^{*} {C}_{s 1} / ( {C}_{s 1} + {C}_{cs 1} ) \qquad equation ( 3 )$$

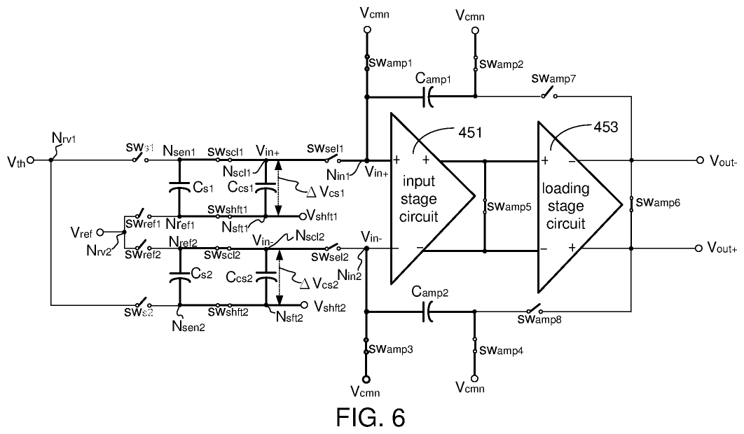

FIG. 7 is a schematic diagram illustrating the gain amplifier operates in the amplification mode (Mₐₘₚ). FIG. 7 is corresponding to the sixth duration T6 shown in FIG. 3B.

When the gain amplifier 45 operates in the amplification mode (Mₐₘₚ), switches swₐₘₚ₁, swₐₘₚ₂, swₐₘₚ₃, swₐₘₚ₄, swₐₘₚ₅, swamps are switched off, and switches swₐₘₚ₇, swₐₘₚ₈ are switched on. Through amplification capacitor Cₐₘₚ₁ and switch swₐₘₚ₇, the first conduction path 45a feedbacks the inverting differential output signal Vₒᵤₜ₋ from the first output terminal Nₒᵤₜ₋ to the first differential input terminal Nᵢₙ₁. Through amplification capacitor Cₐₘₚ₂ and switch swₐₘₚ₈, the second conduction path 45b feedbacks the non-inverting differential output signal Vₒᵤₜ₊ from the second output terminal Nₒᵤₜ₊ to the second differential input terminal Nᵢₙ₂. In FIG. 7, the first conduction path 45a generates the inverting differential output signal Vₒᵤₜ₋ based on the common mode voltage V_{cmn} and the differential input signals (Vᵢₙ₊, Vᵢₙ₋), and the second conduction path 45b generates the non-inverting differential output signal Vₒᵤₜ₊ based on the same.

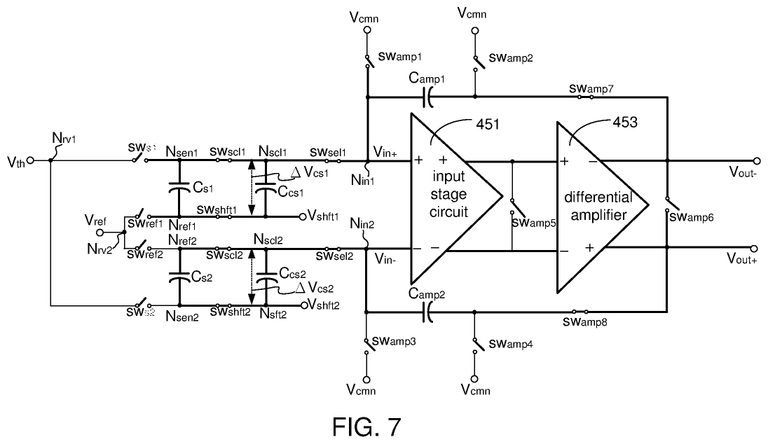

FIG. 8 is a schematic diagram illustrating an example of the implementation of the differential input circuit according to the embodiment of the present disclosure. As shown in FIG. 8, the first sampling switch swₛ₁, the second sampling switch swₛ₂, the first reference switch sw_{ref1}, the second reference switch sw_{ref2}, the first selection switch sw_{scl1}, and the second selection switch swₛₑₗ₂ can be implemented by transmission gates; and the first scaling switch sw_{scl1}, the second scaling switch sw_{shft2}, the first shift switch sw_{shft1}, and the second shift switch sw_{shft2} can be implemented by NMOS transistors. The implementation shown in FIG. 8 is an example, and the implementation in practical applications may vary.

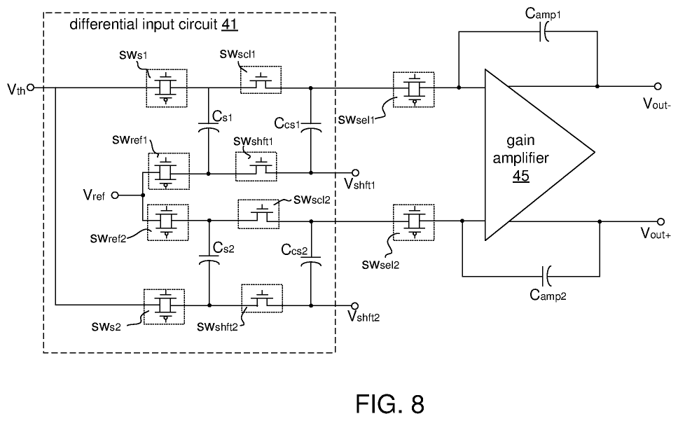

FIG. 9 is a schematic diagram illustrating the characteristic of the differential input circuit according to the embodiment of present disclosure. The horizontal axis represents the input voltage (Vₜₕ−V_{ref}) of the differential input circuit 41, and the vertical axis represents the differential output signals of the differential input circuit 41, that is, the differential input signal of the gain amplifier 45. In FIG. 9, line L1 represents the non-inverting differential input signal Vᵢₙ₊, and line L2 represents the inverting differential output signal Vᵢₙ₋.

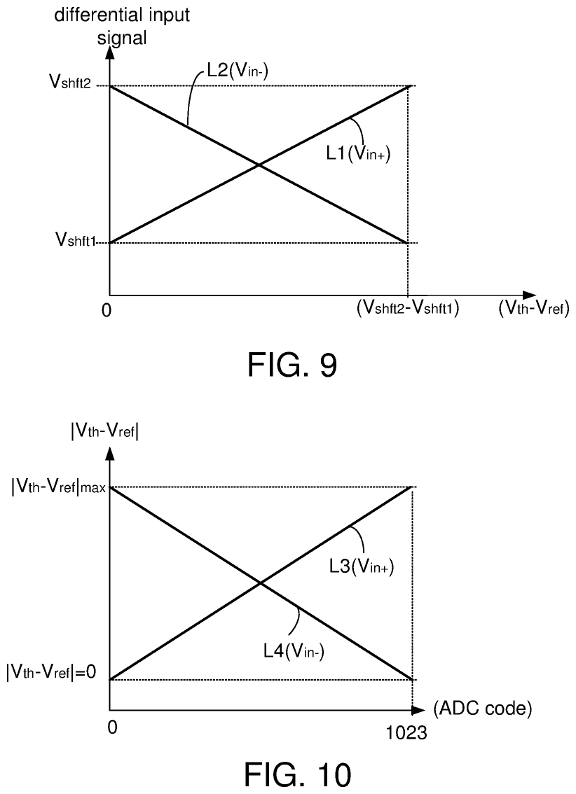

FIG. 10 is a schematic diagram illustrating the conversion curve of the input voltage (Vₜₕ−V_{ref}) of the differential input circuit to the code output by the ADC. The vertical axis represents the input voltage (Vₜₕ−V_{ref}) of the differential input circuit. The horizontal axis represents the ADC code. In FIG. 10, the maximum of the input voltage of the differential input circuit, (Vₜₕ−V_{ref})_{MAX}, is corresponding to the largest ADC code, wherein the resolution of the ADC code is 10 bits as an example. Therefore, the smallest ADC code is assumed to be “0”, and the largest ADC code is assumed to be “1023”. In FIG. 10, line L3 represents the non-inverting differential input signal Vᵢₙ₊, and line L4 represents the inverting differential output signal Vᵢₙ₋.

Under the assumption that the ADC operates in a range of 1V (voltage between the gain amplifier output, that is, |Vout+−Vout−|, is equivalent to 1V (|Vout+−Vout−|=1V), and the gain of the gain amplifier is equivalent to 1, the first shift voltage V_{sft1} can be designed as V_{shft1}=−0.5, and the second shift voltage V_{shft2} can be designed as V_{shft2}=+0.5V in order to satisfy with the relationship that V_{shft2}−V_{shft1}=1V.

In addition, under the same assumption that the down scaling ratio is assumed to be equivalent to ⅓, the input voltage (Vₜₕ−V_{ref}) of the differential input circuit must be less than or equivalent to 3V to ensure that the down-scaled voltage (Vᵢₙ₊−Vᵢₙ₋) is maintained to be less than or equivalent to 1V. That is, the non-inverting differential input signal Vᵢₙ₊ and the inverting differential input signal Vᵢₙ₋ must be satisfied with the following relationship: |Vᵢₙ₊−Vᵢₙ₋|≤|V_{shft1}−V_{shft2}|.

The scenario that the analog voltage signal Vₜₕ is equivalent to the minimum value and equivalent to the reference voltage Vref (for example, Vref=0V, Vth=0V) is discussed. Under such circumstance, the non-inverting differential input signal Vᵢₙ₊ is equivalent to the first shift voltage V_{shft1} (Vᵢₙ₊=−0.5+0*(⅓)=−0.5V=V_{shft1}), according to equation (2). Moreover, according to equation (3), the inverting differential input signal Vᵢₙ₋ is equivalent to the second shift voltage V_{shft2} (Vᵢₙ₋=+0.5+0*(⅓)=+0.5V=V_{shft2}).

The scenario that the analog voltage signal Vth is equivalent to 3V and the reference voltage Vref is equivalent to 0V (Vth=3V and Vref=0V) is discussed. Under such circumstance, the non-inverting differential input signal Vᵢₙ₊ is equivalent to the second shift voltage V_{shft} (Vᵢₙ₊=−0.5V+3*(⅓)V=+0.5V), according to equation (2). Moreover, according to equation (3), the inverting differential input signal Vᵢₙ₋ is equivalent to the first shift voltage V_{shft1} (Vᵢₙ₋=−0.5V+(−3)*(⅓)=−0.5V=V_{shft1}).

When the input voltage of the differential input circuit 41 (Vₜₕ−V_{ref}) is equivalent to zero, the analog voltage signal Vₜₕ is equivalent to the reference voltage V_{ref}, and the first sampling voltage ΔV_{c1} is equivalent to zero. According to equation (1), the non-inverting differential input signal Vᵢₙ₊ can be obtained, that is, Vᵢₙ₊=V_{shft1}+(0)*Cₛ₁/(Cₛ₁+C_{cs1})=V_{shft1}. Similarly, according to equation (3), the inverting differential input signal Vᵢₙ₋ can be obtained, that is, Vᵢₙ₋=V_{shft2}−(0)*Cₛ₁/(Cₛ₁+C_{cs1})=V_{shft2}. Therefore, the non-inverting differential input signal Vᵢₙ₊ is equivalent to the first shift voltage V_{shft1}, and the inverting differential input signal Vᵢₙ₋ is equivalent to the second shift voltage V_{shft2}.

Based on the above illustrations, meanings of the lines L3, L4 in FIG. 10 are illustrated. When the input voltage of the differential input circuit 41, (Vₜₕ−V_{ref}) is equivalent to the minimum value (Vₜₕ−V_{ref})ₘᵢₙ, the differential output (Vₒᵤₜ₊−Vₒᵤₜ₋) of the gain amplifier is equivalent to the minimum value, and the corresponding ADC code is the smallest (ADC code=0). On the other hand, when the input voltage of the differential input circuit, (Vₜₕ−V_{ref}) is equivalent to the maximum value (Vₜₕ−V_{ref})ₘₐₓ, the differential output (Vₒᵤₜ₊−Vₒᵤₜ₋) of the gain amplifier 45 is equivalent to the maximum value, and the corresponding ADC code is the largest (ADC code=1023).

According to the embodiment of the present disclosure, the differential input circuit receives the analog voltage signal Vₜₕ in a single-ended manner but provides a pair of fully differential signals to the gain amplifier. Consequentially, the gain amplifier is not necessary to transform a single-ended input to a differential output. Alternatively speaking, the signal quality of the driving circuit can be improved when the differential input circuit is capable of providing the fully differential signals to the gain amplifier.

Although the illustrations above are based on the OLED display panel, the application of the present disclosure is not limited. Therefore, if there is a need for other display devices having the analog voltage signal to be scaled down, the embodiment of the present disclosure can be modified and applied.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A differential input circuit, for transforming an analog voltage signal corresponding to a sensing line on an OLED panel to a pair of differential input signals being output to a gain amplifier, wherein the differential input circuit comprises:
a sampling circuit, configured to receive the analog voltage signal and a reference voltage, comprising:
a first sampling path, configured to selectively sample the analog voltage signal to generate a first sampling voltage between a first sensing terminal and a first reference terminal according to the analog voltage signal and the reference voltage; and
a second sampling path, configured to selectively sample the analog voltage signal to generate a second sampling voltage between a second reference terminal and a second sensing terminal according to the reference voltage and the analog voltage signal; and
a scaling circuit, comprising:
a first scaling path, electrically connected to the first sensing terminal and the first reference terminal, configured to receive the first sampling voltage and a first shift voltage, down scale the first sampling voltage to a first scaled voltage, and generate one of the pair of differential input signals according to the first shift voltage and the first scaled voltage; and
a second scaling path, electrically connected to the second sensing terminal and the second reference terminal, configured to receive the second sampling voltage and a second shift voltage, down scale the second sampling voltage to a second scaled voltage, and generate the other one of the pair of differential input signals according to the second shift voltage and the second scaled voltage,
wherein the first and the second shift voltages are direct current voltages and the first shift voltage is less than the second shift voltage.

2. The differential input circuit according to claim 1, wherein the first scaling path receives the first shift voltage at a first shift terminal, and the second scaling path receives the second shift voltage at a second shift terminal, wherein a range of the pair of differential input signals is less than or equivalent to difference between the first and the second shift voltages.

3. The differential input circuit according to claim 1, wherein magnitudes of the first sampling voltage and the second sampling voltage are equivalent and polarities of the first sampling voltage and the second sampling voltage are opposite.

4. The differential input circuit according to claim 1, wherein the first sampling path comprises:
a first sampling switch, electrically connected to a first receiving terminal and the first sensing terminal, configured to transmit the analog voltage signal to the first sensing terminal according to a sample enable signal;
a first reference switch, electrically connected to a second receiving terminal and the first reference terminal, configured to transmit the reference voltage to the first reference terminal according to the sample enable signal; and
a first sampling capacitor, electrically connected to the first sensing terminal and the first reference terminal, configured to be charged and generate the first sampling voltage when the first sampling switch and the first reference switch are switched on.

5. The differential input circuit according to claim 4, wherein the first scaling path comprises:
a first scaling switch, electrically connected to the first sensing terminal and a first scaling terminal, configured to conduct the first sensing terminal and the first scaling terminal according to a scaling enable signal;
a first shift switch, electrically connected to the first reference terminal and a first shift terminal, configured to conduct the first reference terminal and the first shift terminal according to the scaling enable signal; and
a first charge sharing capacitor, electrically connected to the first scaling terminal and the first shift terminal, configured to receive the first shift voltage through the first shift terminal, share charges stored in the first sampling capacitor when the first scaling switch and the first shift switch are turned on and accordingly down scale the first sampling voltage to the first scaled voltage, wherein the one of the pair of differential input signals is generated at the first scaling terminal.

6. The differential input circuit according to claim 5, wherein a first scaling ratio between the first scaled voltage and the first sampling voltage is determined based on capacitances of the first sampling capacitor and the first charge sharing capacitor.

7. The differential input circuit according to claim 4, wherein the second sampling path comprises:
a second sampling switch, electrically connected to the first receiving terminal and the second sensing terminal, configured to transmit the analog voltage signal to the second sensing terminal according to the sample enable signal;
a second reference switch, electrically connected to the second receiving terminal and the second reference terminal, configured to transmit the reference voltage to the second reference terminal according to the sample enable signal; and
a second sampling capacitor, electrically connected to the second reference terminal and the second sensing terminal, configured to be charged and generate the second sampling voltage when the second sampling switch and the second reference switch are switched on.

8. The differential input circuit according to claim 7, wherein the second scaling path comprises:
a second scaling switch, electrically connected to the second reference terminal and a second scaling terminal, configured to conduct the second reference terminal and the second scaling terminal according to a scaling enable signal;
a second shift switch, electrically connected to the second sensing terminal and a second shift terminal, configured to conduct the second sensing terminal and the second shift terminal according to the scaling enable signal; and
a second charge sharing capacitor, electrically connected to the second scaling terminal and the second shift terminal, configured to receive the second shift voltage through the second shift terminal, share charges stored in the second sampling capacitor when the second scaling switch and the second shift switch are turned on and accordingly down scale the second sampling voltage to the second scaled voltage, wherein the other one of the pair of differential input signals is generated at the second scaling terminal.

9. The differential input circuit according to claim 8, wherein a second scaling ratio between the second scaled voltage and the second sampling voltage is determined based on capacitances of the second sampling capacitor and the second charge sharing capacitor.

10. A driving circuit of a display device, comprising:
a differential input circuit, for transforming an analog voltage signal corresponding to a sensing line on an OLED panel to a pair of differential input signals, wherein the differential input circuit comprises:
a sampling circuit, configured to receive the analog voltage signal and a reference voltage, comprising:
a first sampling path, configured to selectively sample the analog voltage signal to generate a first sampling voltage between a first sensing terminal and a first reference terminal according to the analog voltage signal and the reference voltage; and
a second sampling path, configured to selectively sample the analog voltage signal to generate a second sampling voltage between a second reference terminal and a second sensing terminal according to the reference voltage and the analog voltage signal; and
a scaling circuit, comprising:
a first scaling path, electrically connected to the first sensing terminal and the first reference terminal, configured to receive the first sampling voltage and a first shift voltage, down scale the first sampling voltage to a first scaled voltage, and generate one of the pair of differential input signals according to the first shift voltage and the first scaled voltage; and
a second scaling path, electrically connected to the second sensing terminal and the second reference terminal, configured to receive the second sampling voltage and a second shift voltage, down scale the second sampling voltage to a second scaled voltage, and generate the other one of the pair of differential input signals according to the second shift voltage and the second scaled voltage,
wherein the first and the second shift voltages are direct current voltages and the first shift voltage is less than the second shift voltage; and
a gain amplifier, electrically connected to the differential input circuit, comprising a first input terminal, a second input terminal, a first output terminal and a second output terminal, configured to receive the pair of differential input signals through the first and the second input terminals and generate a pair of differential output signals at the first and the second output terminals.

11. The driving circuit according to claim 10, wherein the first scaling path receives the first shift voltage at a first shift terminal, and the second scaling path receives the second shift voltage at a second shift terminal, wherein a range of the pair of differential input signals is less than or equivalent to difference between the first and the second shift voltages.

12. The driving circuit according to claim 10, wherein magnitudes of the first sampling voltage and the second sampling voltage are equivalent, and polarities of the first sampling voltage and the second sampling voltage are opposite.

13. The driving circuit according to claim 10, wherein the first sampling path comprises:
a first sampling switch, electrically connected to a first receiving terminal and the first sensing terminal, configured to transmit the analog voltage signal to the first sensing terminal according to a sample enable signal;
a first reference switch, electrically connected to a second receiving terminal and the first reference terminal, configured to transmit the reference voltage to the first reference terminal according to the sample enable signal; and
a first sampling capacitor, electrically connected to the first sensing terminal and the first reference terminal, configured to be charged and generate the first sampling voltage when the first sampling switch and the first reference switch are switched on.

14. The driving circuit according to claim 13, wherein the first scaling path comprises:
a first scaling switch, electrically connected to the first sensing terminal and a first scaling terminal, configured to conduct the first sensing terminal and the first scaling terminal according to a scaling enable signal;
a first shift switch, electrically connected to the first reference terminal and a first shift terminal, configured to conduct the first reference terminal and the first shift terminal according to the scaling enable signal; and
a first charge sharing capacitor, electrically connected to the first scaling terminal and the first shift terminal, configured to receive the first shift voltage through the first shift terminal, share charges stored in the first sampling capacitor when the first scaling switch and the first shift switch are turned on and accordingly down scale the first sampling voltage to the first scaled voltage, wherein the one of the pair of differential input signals is generated at the first scaling terminal.

15. The driving circuit according to claim 13, wherein the second sampling path comprises:
a second sampling switch, electrically connected to the first receiving terminal and the second sensing terminal, configured to transmit the analog voltage signal to the second sensing terminal according to the sample enable signal;
a second reference switch, electrically connected to the second receiving terminal and the second reference terminal, configured to transmit the reference voltage to the second reference terminal according to the sample enable signal; and
a second sampling capacitor, electrically connected to the second reference terminal and the second sensing terminal, configured to be charged and generate the second sampling voltage when the second sampling switch and the second reference switch are switched on.

16. The driving circuit according to claim 15, wherein the second scaling path comprises:
a second scaling switch, electrically connected to the second reference terminal and a second scaling terminal, configured to conduct the second reference terminal and the second scaling terminal according to a scaling enable signal;
a second shift switch, electrically connected to the second sensing terminal and a second shift terminal, configured to conduct the second sensing terminal and the second shift terminal according to the scaling enable signal; and
a second charge sharing capacitor, electrically connected to the second scaling terminal and the second shift terminal, configured to receive the second shift voltage through the second shift terminal, share charges stored in the second sampling capacitor when the second scaling switch and the second shift switch are turned on and accordingly down scale the second sampling voltage to the second scaled voltage, wherein the other one of the pair of differential input signals is generated at the second scaling terminal.

17. The driving circuit according to claim 10, further comprising:
a multiplexer selection circuit, electrically connected to the differential input circuit and the gain amplifier, configured to conduct the pair of differential input signals to the first and the second input terminals of the gain amplifier according to a channel selection signal.

18. The driving circuit according to claim 17, wherein the multiplexer selection circuit further comprises:
a first selection switch, electrically connected to the first scaling terminal and the gain amplifier, configured to conduct the one of the pair of differential input signals to the first input terminal of the gain amplifier; and
a second selection switch, electrically connected to the second scaling terminal and the gain amplifier, configured to conduct the other one of the pair of differential input signals to the second input terminal of the gain amplifier.

19. The driving circuit according to claim 10, wherein the gain amplifier comprises:
an input stage circuit, electrically connected to the first and the second selection switches, configured to receive a common voltage or the pair of differential input signals;
a loading stage circuit, electrically connected to the input stage circuit, configured to generate the pair of differential output signals according to the common voltage or the pair of differential input signals.

20. The driving circuit according to claim 19, wherein
the input stage circuit receives the common voltage when the channel selection signal represents the gain amplifier operates in a common mode; and
the input stage circuit receives the pair of differential input signals when the channel selection signal represents the gain amplifier operates in an amplification mode.
